(19) United States
(12) Patent Application Publication
(10) Pub. No.: US 2005/0021419 A1
(43) Pub. Date: Jan. 27, 2005

(54) Consumer-to-business (C2B) method for consolidating consumer powers in activating market economy

(76) Inventor: Hing Fai Freeman Fung, Hong Kong (HK)

Correspondence Address: Raymond Y. Chan, Suite 128, 108 N. Ynez Ave., Monterey Park, CA, 91754, US

(21) Appl. No.: 10/815,497

(22) Filed: Mar. 31, 2004

Related U.S. Application Data
(63) Continuation-in-part of application No. 09/692,903, filed on Oct. 19, 2000.

(51) Int. Cl. G06F 17/60

(52) U.S. Cl. 705/26

(57) ABSTRACT

A consumer-to-business method by utilizing a secured network to consolidating marketing powers and consumer powers in grouping purchase orders through the global computer network along with the actual franchised stores, centers, and physical locations, to negotiate with the producers or the suppliers for new invention products, provides channels to Inventors to market their invention and Consumers to combine their orders together for negotiating with the manufactures or the suppliers for the goods or services requested and consolidating the marketing powers of the inventors and the purchasing powers of consumers from global computer network.

### CROSS REFERENCE OF RELATED APPLICATION

This is a Continuation-In-Part application of a non-provisional application, application No. 09/692,903, filed Oct. 19, 2000.

### BACKGROUND OF THE PRESENT INVENTION

1. Field of Invention

The present invention relates to a consumer-to-business (C2B) method for consolidating marketing powers and consumer powers in activating market economy for new inventions or designs, wherein some secured networks, such as a global computer network, is utilized to consolidate consumer powers in grouping purchase orders for marketing new invention or innovative products or services, which is huge enough to negotiate with the producers or the suppliers for developing new inventions into marketable products or services.

2. Description of Related Arts

In recent years, the global computer network, or the Internet plays a very important role in the worldwide economy. The Internet affects not only the development of the modern computer and communicating technologies, but also the development of doing the buying and selling business in other means rather than the traditional retailing channels. Especially, the Internet affects the traditional marketplaces that bring buyers and suppliers together.

Since the first auction web site launched at the mid 90's and other similar web sites started the same means of marketplaces within the Internet, people started to realize that the tremendous purchasing power could be formed from the Internet. Nowadays, almost all of the traditional retailing companies worldwide offer to sell their products and services directly through their own web sites or indirectly through paid advertisements within the Internet because the consumers are more willing to purchase through the Internet after all kinds of secured transaction features were added to the web sites.

However, since the natures of these kinds of web sites, consumers are always confined by predetermined products and services provided. Consumers can only select the difference brand names between the predetermined types of existing or well developed products and/or services. They can seldom or never determine what kind of products and/or services that they can buy. The consumers do not have any chance to obtain information of any new invention before the invention is made into marketable products or service. They don't even have chance to express their intention to purchase such invention or design products or services before they are productized and in mass production.

Moreover, since these types of web sites are not selling their own brand named products but acting as venders to the manufacturers or the service providers, the quality of the goods and services may not be guaranteed. Also, in order to buy any goods in a big discount, consumers may always find that they have to purchase used or refurbished products. Sometimes, even they can get a brand new product, but it would be from the discontinue product lines of the manufacturers or from the pervious seasons or even few seasons ago!

In addition, the shipping and handling charges would be the concern to consumers as well. It is reasonable for web site companies to levy a shipping and handling charges if this is the discretion for the consumers have the goods shipped to designated locations. However, since there is no any other alternative offered to the consumer but the only method to obtain the purchased products was through the shipping carriers. It is very unfair to the consumer. Normally, the shipping and handling charges levied by the web site companies are two times or even three times higher than the actual costs of shipping.

Meanwhile, the traditional membership-type department store is one of the important media that brings buyers and suppliers together and transacts businesses. This type of marketplace became the mainstream of providing bargains to their members since the collective purchasing powers of their members.

Consumers buying from these types of department store can be benefited from the relatively lower prices offered by the stores. However, since the nature of the department store is to purchase at volumes in order to obtain discounts from the manufacturers or suppliers and to sell their products in a bulk pack, members are therefore always required to buy the same kind of products at a large volume. Wastage would be one of the possible outcomes if the member cannot fully utilize the purchased products. Or, if the purchased product is food or food related products, wastage is sure if the member cannot consume such product before the product perish. Nevertheless, since the members must buy the bulk pack of the products, the money that they have to put up with in order to enjoy the discounts sustained will always be larger than they buy the same product in an individual package elsewhere.

The cost for any business entity to set up a retailing business is huge. In order to provide its members a lower price at particular item, the business must buy from the supplier at a large volume. It order to provide its members lower prices on difference items, the business must buy from difference suppliers of difference items at large volume. It requires a huge amount of capitals for business to have that kind of inventories. It might not make good economical sense sometimes to stock up inventories especially in times of depression or for those products or goods have fashion nature.

In addition, the cost for developing an invention or design product is huge for independent inventor. The manufacturers generally require the inventors to order a large quantity that may cause a large sum of investment and capital in order to produce the invention or design product. Without marketable products, the independent inventor would neither put the invention or design products or services on market on sale nor do any market search or check out whether the consumers accept the invention or design products or services or not. In order words, it is a common problem for all independent inventors that they have to invest a great amount of capital before they can find out whether the consumers like the invention or design products or service. The independent inventors have nothing to negotiate with the manufacturers or suppliers except investing capital to place order.

### SUMMARY OF THE PRESENT INVENTION

It is a main objective to provide a solution to the above-mentioned problems and concerns, the present invention provides a consumer-to-business (C2B) method for consolidating consumer powers in activating market economy for innovative products by utilizing some secured networks, such as a global computer network, to consolidate consumer powers in grouping purchase orders for marketing new invention or innovative products or services, that will be powerful enough to negotiate for a very special terms and process for the invention or design products or services from the manufacturers and/or the suppliers. The purchasing powers generated will be powerful enough to execute marketing force and create new business trends—Inventors and Consumers are more active and passive in activating invention or design product developments and Market Economy. It may, to certain extent and in some sectors, reverse the flows of the traditional “B2B” (Business to Business) and “B2C” (Business to Consumers) business modes. While consolidating such purchasing power, mark-ups, commission, rebates, membership dues, advertising fees and handling charges will be made as the profits.

Primary, the Powers are especially apply on new invention or design products and services. Certainly, the Powers may also apply on some existing, available goods or services from the market. Secondary, the inventors may request the suppliers to productize their inventions and make required modifications on their inventions to develop a marketable invention or design products and services in accordance to the market needs and the additional; requirements or expectations of the consumers.

It is another objective of the C2B method of the present invention to demand the vendors to produce and supply invention or design products, services, which are brand new and not yet available from the existing market. As the purchasing power according to the present invention is powerful enough, it can reach some extent heading the markets and act positively in some market sectors. It represents the consumers to contribute to and play a very important role in Market Economy. It will study the facts and actual value of products. It is capable of evaluating the cost efficiency and exact acceptable prices for the invention or design products and services. It can activate and speed up the invention or design product developments and consumptions by expressing their common needs with new designs, inventions and patents. It can also benefit the consumers, suppliers, manufacturers, the whole market and then the State Economy.

The Central Processing Center (CPC), which can be an association, organization or Central Processing Center who consolidates consumer powers in running and managing the present C2B commerce system and method, will earn mark-ups, rebates, commissions, handling and advertising fees from those purchases. The Central Processing Center (CPC) can design, create and register its own brand names and trademarks. It can make more profits from purchases and trading of goods with those new brands and marks on “OEM” basics. Its main target is to hold the exclusive rights of those newly designed and specified products. The best profits expected will be coming from product development and from offering licensing and franchises.

It is another objective of the consumer-to-business method of the present invention to provide channels for consumers to have chance to obtain information of new invention or design products or services even before they are mass produced and marketed. Moreover, the consumers have the choice to decide to purchase such new invention or design products and services at the volume and price that they dictate. It also allow the consumers to make their preferences of where they can have their purchased invention or design products to be pick up at no extra cost to them.

It is another objective of the consumer-to-business method of the present invention to look for and develop more new products and services, which are not yet available from the market by grouping the common needs and the purchasing powers. Moreover, as commonly expressed by Members and Consumers and strongly demanded by the market, products will tender for and special make those new invention or design products by the manufacturers or suppliers in according to the new specifications or even newly developed by the Central Processing Center (CPC). As quantities and sales are assured, manufacturers can produce the new invention or design products at a lower price to the Members and Consumers. The CPC may, in some cases, hold on the patents of the newly developed invention or design product and invest with the manufacturer in order to eliminate the anxious of financial stresses of the manufacturer.

### BRIEF DESCRIPTION OF THE DRAWINGS

FIG. 1 is a block diagram illustrating the ordinary procedure of the traditional flows of retailing services starting from the manufacturers.

FIG. 2 is a block diagram illustrating a Consumer-to-Business method according to a preferred embodiment of the present invention.

FIG. 3 is a detailed flow chart illustrating how Members and Consumers purchasing products and services.

FIG. 4 is a block diagram illustrating the procedures of conducting purchasing under the databases generated according to the above preferred embodiment of the present invention.

FIG. 5 is a block diagram illustrating how the negotiations take place according to the above preferred embodiment of the present invention.

FIG. 6 is a block diagram illustrating how to put the new inventions, designs and patents into surveys and implementation of products development according to the above preferred embodiment of the present invention.

### DETAILED DESCRIPTION OF THE PREFERRED EMBODIMENT

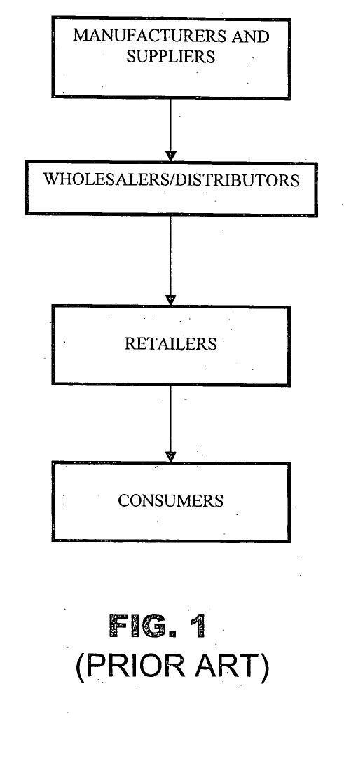

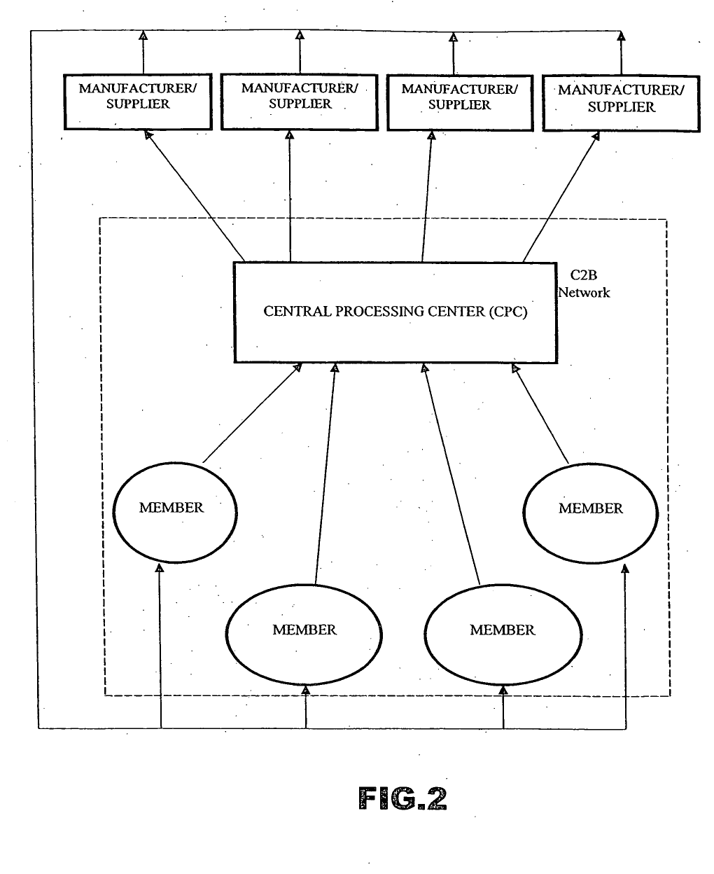

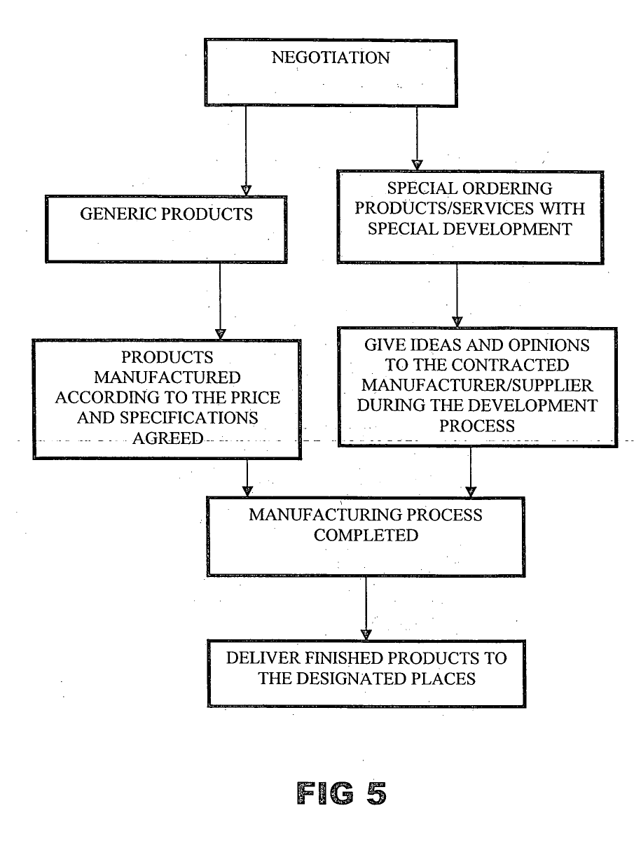

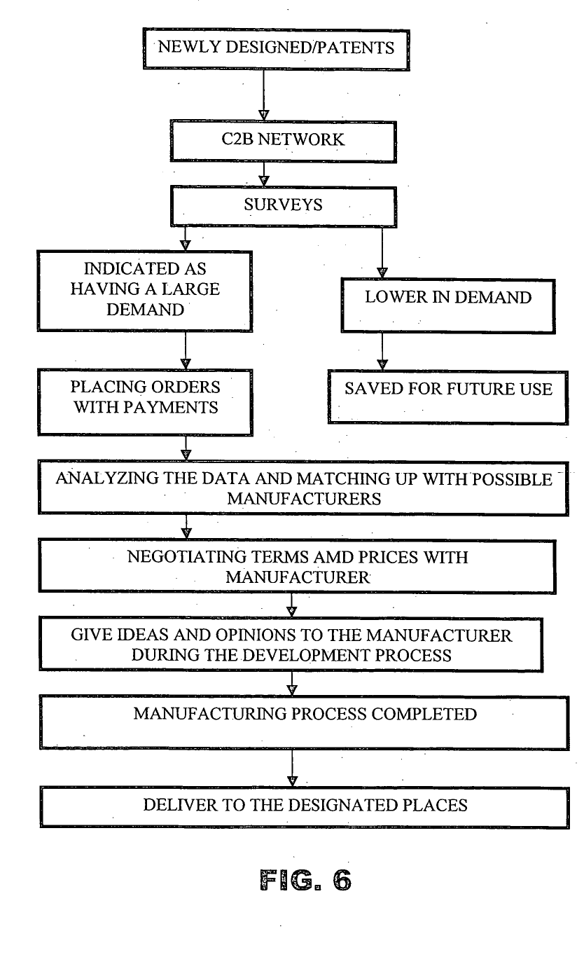

Referring to FIGS. 2 to 6, a Consumer-to-Business (C2B) method for consolidating consumer powers in activating market economy for new inventions or designs according to a preferred embodiment of the present invention is illustrated. As illustrated in FIG. 1, the ordinary way of doing retailing business is started from the manufacturer. However, the present invention is started from the Inventors and Consumers, as shown in FIG. 2. The C2B method provides channels for Inventors to market their inventions or design and check out whether the consumers like and accept them before investing capital to mass produce them. Also, the C2B method also provides channels for Consumers to combine their orders together in order to negotiate with the manufactures or the suppliers for the goods or services requested.

The present C2B method comprising steps of consolidating the marketing powers of inventors and purchasing powers of consumers through one of the communication networks, such as global computer network, steps of purchasing in a huge volume and discounts, steps of marketing new designs, inventions and patents before they are mass produced, steps of testing the marketability on such new designs, inventions and patents, and steps of developing new invention or design products or services in a much more faster and reasonable manner. The consumers not only have chance to obtain information of new invention or design products or services even before they are mass produced and marketed but also can express their common needs and interests for particular products and services and form an influence and take an active control in the economy.

The Consumer-to-Business (C2B) method for consolidating inventor powers and consumer powers in activating market economy according to the present invention comprises the following steps:

1. Provide a Consumer-to-Business (C2B) network.

2. Accepting registration of one or more invention products, including new design or invention goods or services, in an Invention Information Database (IID) of the C2B network storing invention information of the registered invention products provided by Inventors.

When the C2B network is the Internet, the IID should be an electronic database provided in a programmed central processing web site according to the preferred embodiment, wherein a Central Processing Center (CPC) who runs and manages the central processing web site will analyze and group the stored invention information as invention product or service data in difference categories for further uses, wherein:

(a) in order to be registered in the C2B network, the invention information of the invention products must be verified by analyzing their patents and/or inspecting the prototype or detail specification of the design or invention to ensure the invention products are in the state of Reduction-To-Practice (RTP), i.e. the registered invention products can be substantially manufactured or conducted according to the current technology and environment; and

(b) provide a minimum suggested selling price for each of the registered invention products.

3. Store all information given by Members, registered Inventors and Consumers, regarding to the special needs of product and services in a Consumer Information Database (CID) of the C2B network.

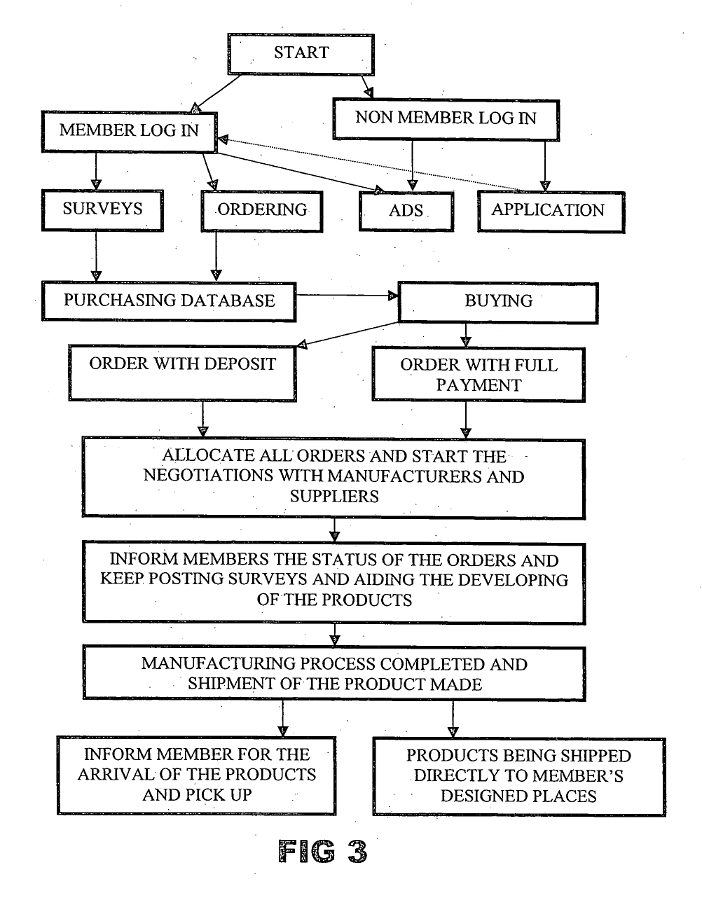

When the C2B network is the Internet, the CID should be an electronic database provided in a programmed central processing web site according to the preferred embodiment, as shown in FIG. 3, wherein:

(a) a consumer can log on the C2B network and the central processing web site has two different sections of web page;

(b) a screen is provided to appear and question whether the consumer is a registered member;

(c) when the consumer is not a registered member, a screen of a brief introduction with advertisements and a membership application form is shown;

(d) an authorization password and the consumer's name will be recognized upon the completion of the registration of the non-registered consumer and the consumer is registered as a Member who now may enter to the C2B network;

(e) whereas, if the Consumer is a Member of the C2B Network, the Member can take part into the surveys regarding his or her interests and needs in different registered invention products;

(f) the Consumer is invited to place an acceptable purchasing price for each of the registered invention products; and

(g) the information provided by the Member is stored in the Consumer Information Database (CID), wherein the Central Processing Center (CPC) who runs and manages the central processing web site will analyze and group the stored information as purchasing data in difference categories for further uses.

4. Use the purchasing data analyzed and grouped from the information provided by the Members to define the actual number of orders needed for each of the registered invention products when the purchasing price suggested by the Consumer to that particular registered design or invention product or service not less than the suggested selling price thereof.

5. After defining the actual numbers of orders, payments as deposits are required from the Members.

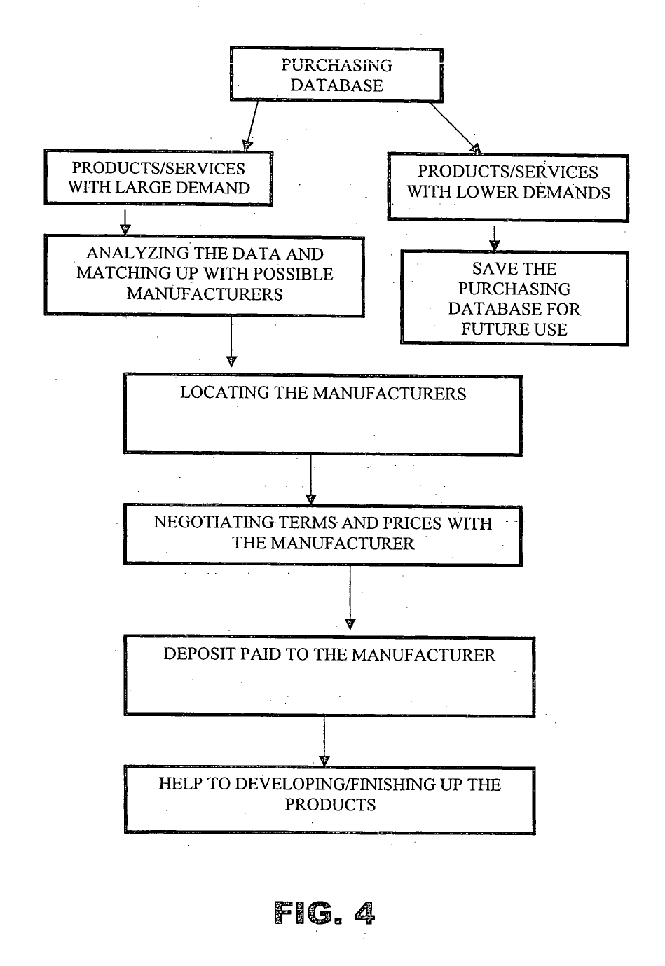

6. As the deposits received, the Central Processing Center (CPC) starts the negotiations process as illustrated in FIG. 4, which further comprises of the following steps:

6-a. The Central Processing Center (CPC) analyzes the purchasing database to determine the most demanded products and services requested by the Members and leave the products and services with the lower demands (below a minimum quantity) for further uses.

6-b. Then, the Central Processing Center (CPC) locates potential manufacturers or suppliers and negotiates for best terms and specifications of the required products or services.

6-c. Upon the agreement made between the Central Processing Center (CPC) and the contracted Manufacturer or Supplier, deposit from the Members is directed to the contracted Manufacturer or Supplier.

6-d. During the manufacturing process, the Central Processing Center (CPC) keeps on inputting useful ideas and information providing by the Members from the continuous surveys conducted after the placement of the order to the contracted Manufacturer or Supplier.

7. The finished products manufactured by the contracted Manufacturer or Supplier are delivered to the Members' designated places or the Central Processing Center's designated places for Members' pick up.

Usually, it is the manufacturers who will decide on what goods to be produced, the suppliers planned on what services to be offered and the distributors who will preset the market price. In Marketing Economy, these conventional kinds of business flows are termed as “B2B” (Central Processing Center to Central Processing Center) and “B2C” (Central Processing Center to Consumer). Hence, most Consumers cannot but have to choose among those available goods and services. In those conventional business flows, they are always dragged along by advertisement and the policies of manufacturers and distributors. Powers of this invention will be in some sectors and to certain extent, reverse those traditional flows of business to “C2B” (Consumer to Central Processing Center), “b2B” (Distributors to Manufacturers). It will demand on the suppliers, the wholesalers, and the manufacturers to produce, provide the required goods and services at certain acceptable prices, conditions and specifications.

The Central Processing Center (CPC) substantially collects invention products form inventors and marketing information from the market and reverts the common needs of the Members. It will issue periodic reports, bulletins, and magazines to acknowledge the Inventors and Members and to collect purchases, hold regular seminars and gatherings to exchange ideas, organize activities to amuse consumers and promote identification.

The Central Processing Center (CPC) also manages the purchases and logistic of goods, maintain meeting points, centers and chain shops for the above purposes, for fellowship and for customers supports. It will also host other different web sites for better communications, collecting purchase orders and ideas, and transfer them into the purchasing database.

Basically, the C2B method of the present invention is good at providing a marketing platform for handling on those invention products before mass production. However, after a well-planned operation of the present invention, the marketing powers of the inventors are greatly increased by direct communication with the consumers through the C2B network, and that the purchasing powers of the consumers will be large enough and the demands for goods are more frequently and regularly. Then, the logistic of goods becomes well organized, the new design or invention products of daily live such as toys, luxuries apparels and fresh food will also be purchased through this C2B method. Specifically, some extra requirements and better qualities can be required due to the large volume of orders generate from this method. The Central Processing Center (CPC) will ask for modified packing, outlooks, contents, compositions of existing goods, revised or specified services in accordance with the common needs of the Members.

The Central Processing Center (CPC) running and managing this C2B method can be of any structures of legal entities, for example, corporation, limited company, limited liability company, holding company, mutual company, public company and etc. It also, can be a membership club, an association, an organization, and a co-operative society. Inventors and consumers can be recruited as Members. The Central Processing Center (CPC) will recruit member or account of consumers from the whole market. For a public company, members can trade and hold the stocks issued by the said public company at their discretion. It substantially consolidates marketing powers from inventors and purchasing powers from consumers to negotiate and obtain better offers, conditions in their purchase. It will set up points, centers and chain shops to communicate and provide services to its members, for example, to pick up the ordered or purchased products without paying the shipping and handling charges. For far reaching areas and foreign countries, it will appoint or franchise agents, representative, distributors to achieve those targets.

The Central Processing Center (CPC) can evaluate the values, test the contents, and study the qualities of products and issues reports on findings. It also reverts the ideas and needs of the Members and other relative consumers on reports, magazines and web sites. Products intent to be purchased will be chosen by recommendations of the Central Processing Center (CPC) or by the expressions of the Members. They will be announced with an acceptable price, which is already better than the price from the open market. The more purchasing powers collected, the bigger forces in obtaining discounts and favors from vendors will be generated.

After the announcements, Members will express their interests of purchasing the registered invention products. The total votes constitute the strength of purchasing powers. It then negotiates or calls tender for special make of those specific items and quantities of registered new design or invention products. The final quotes will then be announced again and ask for payments or deposits from the Members who expressly agreed to purchase the produces or services. If the actual purchases collected are close to or more than expected, additional gratitude will be given to Members. If the actual purchases collected are lower and outside the acceptable ranges, the manufacturer may revise buying prices and conditions or cancel the deal.

In some cases, the Central Processing Center (CPC) may ask suppliers to deliver goods directly to its Members. In other cases, goods can be delivered to the Central Processing Center's meeting points, centers, warehouses, and chain shops at the discretions of the Members who placed such orders. Or, the products may be delivered by the Central Processing Center's own crews. The Central Processing Center will computerize and fully control the operations, management, logistic and administration of all goods under its purchases including the processes of collection payments. The Central Processing Center (CPC) also requests and administers the customers' supports.

The Central Processing Center (CPC) also collects ideas, designs, expressions and common needs of the Inventors and Consumers registered as Members. In purchasing and demanding production of new products, the CPC licenses or purchases valuable patents. The CPC also develops its own designs, inventions and recommends new products to Members to purchase. The CPC will hold Patents by itself on those innovated ideas, new designs, generated goods and developed products.

In addition to buying goods of existing brands, the Central Processing Center (CPC) may hold its own brand names and trade markets for goods under its own designs and patents. The CPC purchases and trades those goods on an “OEM” basis. That is, beside buying goods for its Members, the Central Processing Center (CPC) may order additional quantity to trade, distribute locally and overseas on those “OEM” products to open markets for further profits.

While making business with the C2B method, the Central Processing Center (CPC) can, at the same time, authorize and sell franchises of this C2B method. Franchises can be on different areas, cities and countries. Franchises can also be lent on specific products, for example financial products, real estate and foodstuffs. The franchised Central Processing Center (CPC) can be of its own holding Central Processing Center or its own subsidiaries. They can also be some other distributors or agent of unrelated Central Processing Center (CPC).

The present C2B method provides an interpersonal relations and identification. While holding some regular seminars, meetings, the CPC also from time to time organizes activities in its meeting points, centers and chain stores for Members. The CPC can also set up welfare funds for the Members to solve some of their difficulties and unfortunates.

Normally, investor, manufacturers give the financial stresses and stock pressures a serious consideration in developing new products. Capitals involved and debt risks will be much lower and the return of profits will be forecasted accurately if the new design or invention product or service development is conducted under the present method.

In addition, individual inventors and patentees can turn in their inventions and patents to the Central Processing Center (CPC) and let the CPC conduct surveys and see if those inventions and patents are marketable or not. If the purchasing powers can be generated during the surveys, the Central Processing Center (CPC) may place the orders with manufacturer along with the profit-share plan with the inventor or the patentee. By doing so, more and more patents and inventions can be turned into an actual product and benefit the general public in a much faster and reasonable ways.

Transactions conducted under the present C2B method will be very cost efficient. The manufacturers and vendor supplying goods to Members of the Central Processing Center will spend no or very little on product promotions and advertising. Their low selling prices will be easily counter balanced by saving a lot. The Central Processing Center (CPC) of the present C2B method will help them run a higher turnover with low profit margins' business. The C2B method can also regulate the inertia of price mechanism in the market. The CPC will grow up and play an important role in market diversification.

With the present C2B method, bodies taking part in the business will all be benefited. It can stimulate spending and consumption, create employments while in Bear Economy. It can also regular the process, suppress inflations while in Bull Economy. It can shorten the distances between the supply and demand chains, speed up the development and manufacture of some new products.

The term of “Consumer Base Market” have been defined in economy for years. Yet, it is not really or totally executed. Investor, manufacturers and suppliers are till the bodies that decide on what to be produced and at what price. Consumers are still dragged along by the policies, campaigns and advertisements delivered from the supply chains and their choices are from those available goods only. With the present C2B method, involved Consumers will be more active and passive in product finding, developments and finally, in fixing the acceptable prices. These practices will push the market much closed to a “Real Consumer Base Market”.

Meanwhile, the electronic commerce (E-commerce) are prevailing and dominating larger and larger sectors of the Market and Economy. Without interpersonal contacts, consumers will complete their purchases from the cool screens only without the services and being acknowledged. Of course, besides electronic mail transaction, it is also worth to mention that the C2B network can also be communicated through paper mail transaction. The present C2B method can turn these virtual communities back to realistic communities. Inventors and Consumers can express their ideas and needs, collect information from the meeting points, center, web sites and chain shops. Besides taking part in regular seminars and activities, they will also play drop in visits for purchasing and fellowship purposes. They will also enjoy the after sales services and welfare provided by the Central Processing Center.

1. A Consumer-to-Business method for consolidating consumer powers in activating market economy, comprising the steps of:
(a) providing a Consumer-to-Business (C2B) network;
(b) accepting registration of one or more invention products in an Information Database of said C2B network storing invention information of said invention products provided by Inventors;
(c) storing information given by registered Consumers regarding to specific needs of product in said Information Database of said C2B network;
(d) determining one or more ordered invention products from said invention products according to said information provided by said registered Consumers;
(e) requesting payments from said registered Consumers for said ordered invention products of said registered Consumers;
(f) determining and contracting one or more Suppliers as contracted Suppliers to purchase said ordered invention products; and
(g) delivering said order products from said contracted Suppliers to places designated by said registered Consumers respectively.

2. The method, as recited in claim 1, wherein said invention products include invention goods or services.

3. The method, as recited in claim 1, wherein said central processing web site is ran and managed in a Central Processing Center (CPC) to analyze and group said stored invention information as invention product data in a plurality of categories.

4. The method, as recited in claim 2, wherein said central processing web site is ran and managed in a Central Processing Center (CPC) to analyze and group said stored invention information as invention product data in a plurality of categories.

5. The method, as recited in claim 4, wherein the step (a) further comprises a step (a-1) of verifying said invention information of said invention products in order to be registered in said C2B network to ensure that said invention products are in the state of Reduction-To-Practice.

6. The method, as recited in claim 5, wherein the step (a) further comprises a step (a-2) of providing a minimum suggested selling price for each of said registered invention products.

7. The method, as recited in claim 1, wherein the step (b) further comprises the steps of:
(b-1) taking part into surveys regarding interests and needs in said invention products for each of said registered Consumers; and
(b-2) storing said information provided by said registered Consumers into a purchasing database, wherein said information is analyzed and grouped in a plurality of categories by said Central Processing Center (CPC).

8. The method, as recited in claim 4, wherein the step (b) further comprises the steps of:
(b-1) taking part into surveys regarding interests and needs in said invention products for each of said registered Consumers; and
(b-2) storing said information provided by said registered Consumers into a purchasing database, wherein said information is analyzed and grouped in a plurality of categories by said Central Processing Center (CPC).

9. The method, as recited in claim 6, wherein the step (b) further comprises the steps of:
(b-1) taking part into surveys regarding interests and needs in said invention products for each of said registered Consumers; and
(b-2) storing said information provided by said registered Consumers into a purchasing database, wherein said information is analyzed and grouped in a plurality of categories by said Central Processing Center (CPC).

10. The method, as recited in claim 1, wherein the step (c) further comprises a step of inviting said registered Consumers to place acceptable purchasing prices for said registered invention products respectively.

11. The method, as recited in claim 8, wherein the step (c) further comprises a step of inviting said registered Consumers to place acceptable purchasing prices for said registered invention products respectively, wherein the step (d) further comprises a step of using purchasing data analyzed and grouped from said information provided by said registered Consumers to define an actual number of orders needed for each of said registered invention products.

12. The method, as recited in claim 9, wherein the step (c) further comprises a step of inviting said registered Consumers to place acceptable purchasing prices for said registered invention products respectively, wherein the step (d) further comprises a step of using purchasing data analyzed and grouped from said information provided by said registered Consumers to define an actual number of orders needed for each of said registered invention products when said purchasing price suggested by said registered Consumers thereto is equal to or more than said suggested selling price thereof.

13. The method, as recited in claim 8, wherein the step (f) further comprise the steps of:
(f-a) analyzing said purchasing database by said Central Processing Center (CPC) to determine most demanded invention products from said registered invention products requested by said registered Consumers and leave other said registered invention products with lower demands for further uses;
(f-b) locating potential suppliers and negotiating for best terms and specifications of said demanded invention products by Central Processing Center (CPC); and
(f-c) placing deposit from said registered Consumers directly to said contracted Supplier upon agreement made between said Central Processing Center (CPC) and said contracted Supplier.

14. The method, as recited in claim 9, wherein the step (f) further comprise the steps of:
(f-a) analyzing said purchasing database by said Central Processing Center (CPC) to determine most demanded invention products from said registered invention products requested by said registered Consumers and leave other said registered invention products with lower demands for further uses;
(f-b) locating potential suppliers and negotiating for best terms and specifications of said demanded invention products by Central Processing Center (CPC); and
(f-c) placing deposit from said registered Consumers directly to said contracted Supplier upon agreement made between said Central Processing Center (CPC) and said contracted Supplier.

15. The method, as recited in claim 8, wherein the step (c) further comprises the steps of:
(c-1) logging on said C2B network by a Consumer; and
(c-2) determining whether said Consumer logged on is one of said registered Consumer.

16. The method, as recited in claim 15, wherein the step (c) further comprises the steps of:
(c-3) providing a screen of a brief introduction with advertisements along with application form when said logged on Consumer is not one of said registered Consumers; and
(c-4) assigning an authorization password for said Consumer to register said Consumer as a new registered Consumer to be capable of entering said C2B network.

17. The method, as recited in claim 11, wherein the step (c) further comprises the steps of:
(c-1) logging on said C2B network by a Consumer;
(c-2) determining whether said Consumer logged on is one of said registered Consumer;
(c-3) providing a screen of a brief introduction with advertisements along with application form when said logged on Consumer is not one of said registered Consumers; and
(c-4) assigning an authorization password for said Consumer to register said Consumer as a new registered Consumer to be capable of entering said C2B network.

18. The method, as recited in claim 1, wherein said C2B network is an Internet, and said Information Database is an electronic database provided in a programmed central processing web site.

19. The method, as recited in claim 11, wherein said C2B network is an Internet, and said Information Database is an electronic database provided in a programmed central processing web site.

20. The method, as recited in claim 8, further comprising a step of market testing each of said registered invention products by posting surveys in said C2B network, so as to enabling said registered Consumers to indicate interests thereof on said registered invention product.

21. The method, as recited in claim 11, further comprising a step of market testing each of said registered invention products by posting surveys in said C2B network, so as to enabling said registered Consumers to indicate interests thereof on said registered invention product.

22. The method, as recited in claim 14, further comprising a step of market testing each of said registered invention products by posting surveys in said C2B network, so as to enabling said registered Consumers to indicate interests thereof on said registered invention product.
